(19) United States
(12) Patent Application Publication
(10) Pub. No.: US 2021/0406169 A1
(43) Pub. Date: Dec. 30, 2021

(54) SELF-ADAPTIVE WEAR LEVELING METHOD AND ALGORITHM

(71) Applicant: Micron Technology, Inc., Boise, ID (US)

(72) Inventors: Dionisio Minopoli, Arzano (IT); Daniele Balluchi, Cernusco Sul Naviglio (IT); Gianfranco Ferrante, San Giorgio A Cremano (IT)

(21) Appl. No.: 16/962,726

(22) PCT Filed: Oct. 9, 2019
(86) PCT No.: PCT/IB2019/000970

§ 371 Date: Jul. 16, 2020

(51) Int. Cl. G06F 12/02; G06F 12/06

(52) U.S. Cl. CPC G06F 12/0246; G06F 12/0292; G06F 2212/7201; G06F 2212/7211; G06F 12/0653

(57) ABSTRACT

A memory device is provided. The memory device comprises:
a plurality of memory cells, each memory cell being programmable to at least two logic states, each logic state corresponding to a respective nominal electric resistance value of the memory cell, the plurality of memory cells comprising a first group of memory cells and a second group of memory cells, the memory cells of the second group being programmed to a predefined logic state of said at least two logic states;
a memory controller coupled to the plurality of memory cells and configured to apply a reading voltage to at least one selected memory cell of the first group during a reading operation to assess the logic state thereof.

The memory controller is further configured to:
apply the reading voltage to the memory cells of the second group to assess the logic state thereof;
if the logic state of at least one memory cell of the second group is assessed to be different from said predefined logic state, perform a refresh operation of the memory cells of the first group by applying thereto a recovery voltage higher than the reading voltage to assess the logic state thereof and then reprogramming the memory cells of the first group to the logic state assessed with the recovery voltage.

### PRIORITY INFORMATION

This application is a U.S. National Stage Application under 35 U.S.C. § 371 of International Application Number PCT/IB2019/000970, filed on Oct. 9, 2019, the contents of which are incorporated herein by reference.

### DESCRIPTION

### Technical Field

The present disclosure relates generally to semiconductor memory and methods, and more particularly, to a self-adaptive wear leveling method and algorithm.

### BACKGROUND

As it is well known in this technical field, memory devices are typically provided as internal, semiconductor, integrated circuits and/or external removable devices in computers or other electronic devices. There are many different types of memory devices including volatile and non-volatile memory. Volatile memory can require power to maintain its data and can include random-access memory (RAM), dynamic random access memory (DRAM), and synchronous dynamic random access memory (SDRAM), among others. Non-volatile memory can retain stored data when not powered and can include storage memory such as NAND flash memory, NOR flash memory, phase change random access memory (PCRAM), resistive random access memory (RRAM), and magnetic random access memory (MRAM), among others.

“Main memory” is a term used in this art for describing memory storing data that can be directly accessed and manipulated by a processor. An example of a main memory is a DRAM. A main memory provides primary storage of data and can be volatile or non-volatile; for instance, a non-volatile RAM managed as main memory can be a non-volatile dual-in-line memory module known as NV-DIMM.

Secondary storage can be used to provide secondary storage of data and may not be directly accessible by the processor.

Memory devices can be combined together to form a storage volume of a memory system such as a solid state drive (SSD). An SSD can include non-volatile memory (e.g., NAND flash memory and/or NOR flash memory), and/or can include volatile memory (e.g., DRAM and/or SRAM), among various other types of non-volatile and volatile memory.

An SSD may have a controller handling a local primary storage to enable the SSD to perform relatively complicated memory management operations for the secondary storage. However, local primary storage for a controller is limited and relatively expensive resource as compared to most secondary storage.

A significant portion of the local primary storage of a controller may be dedicated to store logical to physical tables that store logical address to physical address translation for logical address.

A logical address is the address at which the memory unit (i.e. a memory cell, a data sector, a block of data, etc.) appears to reside from the perspective of an executing application program and may be an address generated by a host device or a processor. On the contrary, a physical address is a memory address that enables the data bus to access a particular unit of the physical memory, such as a memory cell, a data sector or a block of data.

In this context it is very important that the memory device is configured to allow relocation of data currently stored in one physical location of the memory to another physical location of the memory. This operation is known as wear leveling and is a technique useful to prolong the service life of the memory device otherwise affected by too many writing cycles thus rendering individually writable segments unreliable.

The aim of the present disclosure is that of disclosing a self-adaptive wear leveling method and algorithm improving the features of the known wear leveling solution adopted up to now.

### BRIEF DESCRIPTION OF THE DRAWINGS

FIG. 1 illustrates a diagram of a portion of a memory array having a plurality of physical blocks in accordance with an embodiment of the present disclosure;

FIG. 2 is a block diagram of a computing system including a host and an apparatus in the form of a memory device in accordance with an embodiment of the present disclosure;

FIG. 3 shows a schematic view of a Logical-to-Physical (L2P) table architecture according to embodiments of the present disclosure;

FIG. 4 shows schematically a second level table (SLT) structure according to embodiments of the present disclosure;

FIG. 5 shows a more detailed view of the structure of a L2P table segment according to embodiments of the present disclosure;

FIG. 6 shows a circular list of physical memory positions of the L2P table according to embodiments of the present disclosure;

FIG. 7 is another schematic view showing the list of FIG. 6 in combination with a new proposed table swapping mechanism according to embodiments of the present disclosure;

FIG. 8 shows a flowchart of an algorithm implementing a method of the present disclosure;

FIG. 9 shows a flowchart of another algorithm concerning a method for managing a self-adaptive static threshold wear leveling according to embodiments of the present disclosure;

FIG. 10 shows an example of how the self-adjustment algorithm of the FIGS. 8 and 9 operates with two workloads having different hotness characteristics according to embodiments of the present disclosure;

FIG. 11 shows an implementation example concerning three subsequent writing cycles of a SLT Table on the same physical table address (PTA) according to embodiments of the present disclosure;

FIG. 12 shows a result of simulations with and without L2P Segment scrambling according to embodiments of the present disclosure.

### DETAILED DESCRIPTION

The present disclosure relates to apparatuses, methods, and systems for data relocation in memory having two portions of data. An embodiment includes a memory having a plurality of physical blocks of memory cells, and a first and second portion of data having a first and second, respectively, number of logical block addresses associated therewith. Two of the plurality of physical blocks of cells do not have data stored therein. Circuitry is configured to relocate the data of the first portion that is associated with one of the first number of logical block addresses to one of the two physical blocks of cells that don't have data stored therein, and relocate the data of the second portion that is associated with one of the second number of logical block addresses to the other one of the two physical blocks of cells that don't have data stored therein. A logical to physical (L2P) table is up-dated to reflect the change in physical address of data stored in the wear levelled blocks. The L2P table may have different levels, e.g., a first level table and a second level table, without limitations to the number of table levels.

The endurance is a key characteristic of a memory technology. Once memory cells reach the max number of allowed write cycles, they are no longer reliable (end of life).

This disclosure proposes a L2P table architecture for bit alterable NVM and wear leveling algorithms to control the memory cells aging.

In general, wear leveling algorithms monitor the number of times physical addresses are written and change logical to physical mapping based on write counters values.

A wear-leveling operation can include and/or refer to an operation to relocate data currently being stored in one physical location of a memory to another physical location of the memory. Performing such wear-leveling operations can increase the performance (e.g., increase the speed, increase the reliability, and/or decrease the power consumption) of the memory, and/or can increase the endurance (e.g., lifetime) of the memory.

Previous or known wear-leveling operations may use tables to relocate the data in the memory. However, such tables may be large (e.g., may use a large amount of space in the memory), and may cause the wear-leveling operations to be slow. Moreover, memory cells storing table information needs to be updated during wear leveling operations, so that such memory cells may undergo accelerated aging.

On the contrary, operations (e.g., wear-leveling operations) to relocate data in accordance with the present disclosure may maintain an algebraic mapping (e.g., an algebraic mapping between logical and physical addresses) for use in identifying the physical location (e.g., physical block) to which the data has been relocated. Accordingly, operations to relocate data in accordance with the present disclosure may use less space in the memory, and may be faster and more reliable, than previous wear-leveling operations.

In one embodiment of the present disclosure, during an updating phase of a wear leveling algorithm, a second level table is moved to a different physical location when even a single sector of a second level table has been excessively rewritten.

This solution has the great advantage to keep limited the size of the first level table FLT that is implemented by an expensive volatile memory portion.

In other words, according to the solution proposed in the present disclosure it is sufficient that a single segment of a second level table has reached a predetermined amount of rewriting cycles to change the whole second level table for the subsequent updating phase.

One embodiment of the present disclosure relates to a self-adaptive wear leveling method for a managed memory device wherein a first level table addresses a plurality of second level tables including pointers to the memory device, comprising:
detecting a number of updating phases of a segment of said second level table;
shifting one of the second level tables to a location of another second level table based on the number meeting a defined threshold.

It is worthwhile noting that in above self-adaptive wear leveling method the detecting phase includes reading a value of an updating counter provided in the same segment of the second level table as the L2P entry that is being updated. The shifting phase may include shifting the whole one second level table to a physical location that is different from a starting physical location of the one second level table, for example to a physical location of another second level table that has been accessed less extensively.

The memory component on which the present disclosure is focused may include (e.g., be separated and/or divided into) two different portions (e.g., logical regions) of data, as will be further described herein. In such instances, previous wear-leveling operations may have to be independently applied to each respective portion of the memory (e.g., separate operations may need to be used for each respective portion), and the data of each respective portion may only be relocated across a fraction of the memory (e.g., the data of each respective portion may remain in separate physical regions of the memory). However, such an approach may be ineffective at increasing the performance and/or endurance of the memory. For instance, since the size of, and/or workload on, the two different logical regions can be different, one of the physical regions may be stressed more than the other one in such an approach.

In contrast, operations (e.g., wear-leveling operations) to relocate data in accordance with the present disclosure may work (e.g., increase performance and/or endurance) more effectively on memory that includes two different portions than previous wear-leveling operations. For example, an operation to relocate data in accordance with the present disclosure may be concurrently applied to each respective portion of the memory (e.g., the same operation can be used on both portions). Further, the data of each respective portion may be relocated across the entire memory (e.g., the data of each respective portion may slide across all the different physical locations of the memory). Accordingly, operations to relocate data in accordance with the present disclosure may be able to account (e.g., compensate) for a difference in size and/or workload of the two portions.

Further, previous wear-leveling operations may not be implementable in hardware. In contrast, operations (e.g., wear-leveling operations) to relocate data in accordance with the present disclosure may be implementable (e.g., completely implementable) in hardware. For instance, operations to relocate data in accordance with the present disclosure may be implementable in the controller of the memory, or within the memory itself. Accordingly, operations to relocate data in accordance with the present disclosure may not impact the latency of the memory and may not add additional overhead to the memory. In some embodiments, the disclosed solution may be implemented, at least in part, in firmware and/or in software.

Although embodiments are not limited to a particular type of memory or memory device, operations (e.g., wear-leveling operations) to relocate data in accordance with the present disclosure can be performed (e.g., executed) on a hybrid memory device that includes a first memory array that can be a storage class memory and a number of second memory arrays that can be NAND flash memory. For example, the operations can be performed on the first memory array and/or the second number of memory arrays to increase the performance and/or endurance of the hybrid memory.

As used herein, “a”, “an”, or “a number of” can refer to one or more of something, and “a plurality of” can refer to two or more such things. For example, a memory device can refer to one or more memory devices, and a plurality of memory devices can refer to two or more memory devices.

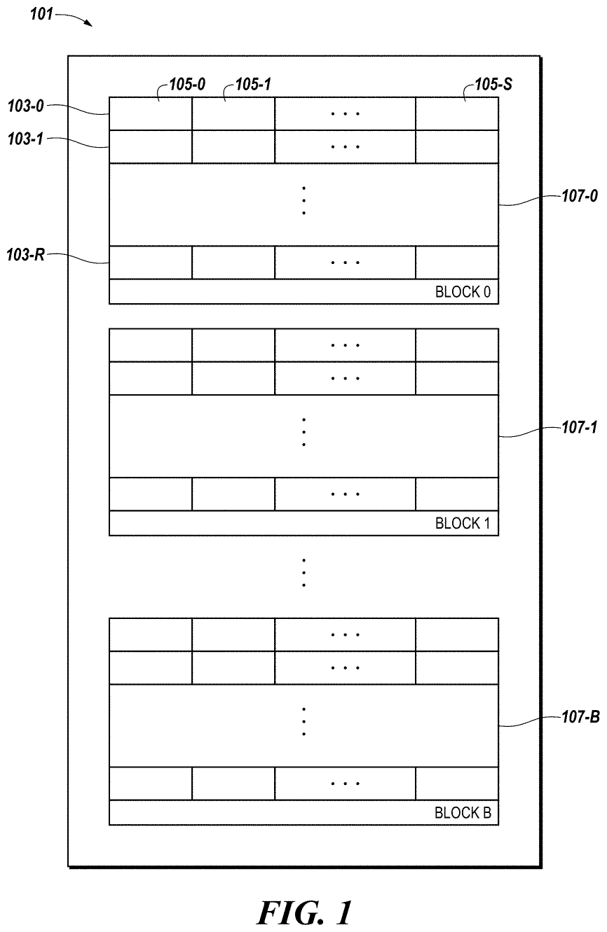

As shown in FIG. 1, each physical block 107-0, 107-1, . . . , 107-B includes a number of physical rows (e.g., 103-0, 103-1, . . . , 103-R) of memory cells coupled to access lines (e.g., word lines). The number of rows (e.g., word lines) in each physical block can be 32, but embodiments are not limited to a particular number of rows 103-0, 103-1, . . . , 103-R per physical block.

Furthermore, although not shown in FIG. 1, the memory cells can be coupled to sense lines (e.g., data lines and/or digit lines).

As one of ordinary skill in the art will appreciate, each row 103-0, 103-1, . . . , 103-R can include a number of pages of memory cells (e.g., physical pages). A physical page refers to a unit of programming and/or sensing (e.g., a number of memory cells that are programmed and/or sensed together as a functional group).

In the embodiment shown in FIG. 1, each row 103-0, 103-1, . . . , 103-R comprises one physical page of memory cells. However, embodiments of the present disclosure are not so limited. For instance, in an embodiment, each row can comprise multiple physical pages of memory cells (e.g., one or more even pages of memory cells coupled to even-numbered bit lines, and one or more odd pages of memory cells coupled to odd numbered bit lines). Additionally, for embodiments including multilevel cells, a physical page of memory cells can store multiple pages (e.g., logical pages) of data (e.g., an upper page of data and a lower page of data, with each cell in a physical page storing one or more bits towards an upper page of data and one or more bits towards a lower page of data).

In an embodiment of the present disclosure, and as shown in FIG. 1, a page of memory cells can comprise a number of physical sectors 105-0, 105-1, . . . , 105-S (e.g., subsets of memory cells). Each physical sector 105-0, 105-1, . . . , 105-S of cells can store a number of logical sectors of data. Additionally, each logical sector of data can correspond to a portion of a particular page of data. As an example, a first logical sector of data stored in a particular physical sector can correspond to a logical sector corresponding to a first page of data, and a second logical sector of data stored in the particular physical sector can correspond to a second page of data. Each physical sector 105-0, 105-1, . . . , 105-S, can store system and/or user data, and/or can include overhead data, such as error correction code (ECC) data, logical block address (LBA) data, and metadata.

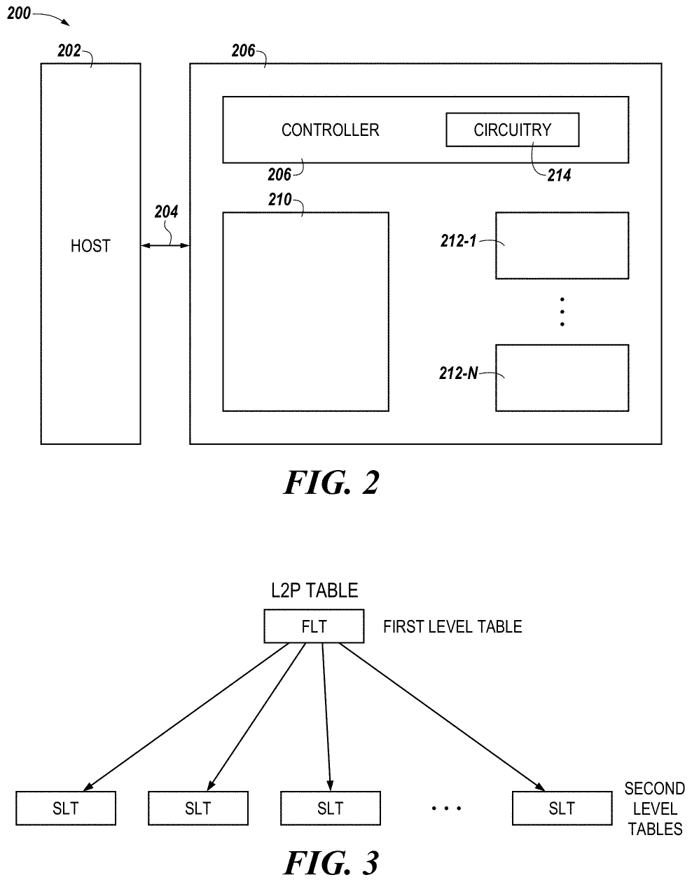

Logical block addressing is a scheme that can be used by a host for identifying a logical sector of data. For example, each logical sector can correspond to a unique logical block address (LBA). Additionally, an LBA may also correspond (e.g., dynamically map) to a physical address, such as a physical block address (PBA), that may indicate the physical location of that logical sector of data in the memory. A logical sector of data can be a number of bytes of data (e.g., 256 bytes, 512 bytes, 1,024 bytes, or 4,096 bytes). However, embodiments are not limited to these examples. Further, in an embodiment of the present disclosure, memory array 101 can be separated and/or divided into a first logical region of data having a first number of LBAs associated therewith, and a second logical region of data having a second number of LBAs associated therewith, as will be further described herein (e.g., in connection with FIG. 2).

It is noted that other configurations for the physical blocks 107-0, 107-1, . . . , 107-B, rows 103-0, 103-1, . . . , 103-R, sectors 105-0, 105-1, . . . , 105-S, and pages are possible. For example, rows 103-0, 103-1, . . . , 103-R of physical blocks 107-0, 107-1, . . . , 107-B can each store data corresponding to a single logical sector which can include, for example, more or less than 512 bytes of data.

FIG. 2 is a block diagram of an electronic or a computing system 200 including a host 202 and an apparatus in the form of a memory device 206 in accordance with embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. Further, in an embodiment, computing system 200 can include a number of memory devices analogous to memory device 206.

In the embodiment illustrated in FIG. 2, memory device 206 can include a first type of memory (e.g., a first memory array 210) and a second type of memory (e.g., a number of second memory arrays 212-1, . . . , 212-N). The memory device 206 can be a hybrid memory device, where memory device 206 includes the first memory array 210 that is a different type of memory than the number of second memory arrays 212-1, . . . , 212-N.

The first memory array 210 can be storage class memory (SCM), which can be a non-volatile memory that acts as main memory for memory device 206 because it has faster access time than the second number of memory arrays 212-1, . . . , 212-N. For example, the first memory array 210 can be 3D XPoint memory, FeRAM, or resistance variable memory such as PCRAM, RRAM, or STT, among others. The second number of memory arrays 212-1, . . . , 212-N can act as a data store (e.g; storage memory) for memory device 206, and can be NAND flash memory, among other types of memory.

Although the embodiment illustrated in FIG. 2 includes one memory array of the first type of memory, embodiments of the present disclosure are not so limited. For example, in an embodiment, memory device 206 can include a number of SCM arrays. However, memory device 206 may include less of the first type of memory than the second type of memory. For example, memory array 210 may store less data than is stored in memory arrays 212-1, . . . , 212-N.

Memory array 210 and memory arrays 212-1, . . . , 212-N can each have a plurality of physical blocks of memory cells, in a manner analogous to memory array 101 previously described in connection with FIG. 1. Further, the memory (e.g., memory array 210, and/or memory arrays 212-1, . . . , 212-N) can include (e.g., be separated and/or divided into) two different portions (e.g., logical regions) of data. For instance, the memory may include a first portion of data having a first number (e.g., first quantity) of logical block addresses (LBAs) associated therewith, and a second portion of data having a second number (e.g., second quantity) of LBAs associated therewith. The first number of LBAs can include, for instance, a first sequence of LBAs, and the second number of LBAs can include, for instance, a second sequence of LBAs.

As an example, the first portion of data may comprise user data, and the second portion of data may comprise system data. As an additional example, the first portion of data may comprise data that has been accessed (e.g., data whose associated LBAs have been accessed) at or above a particular frequency during program and/or sense operations performed on the memory, and the second portion of data may comprise data that has been accessed (e.g., data whose associated LBAs have been accessed) below the particular frequency during program and/or sense operations performed on the memory. In such an example, the first portion of data may comprise data that is classified as “hot” data, and the second portion of data may comprise data that is classified as “cold” data. As an additional example, the first portion of data may comprise operating system data (e.g., operating system files), and the second portion of data may comprise multimedia data (e.g., multimedia files). In such an example, the first portion of data may comprise data that is classified as “critical” data, and the second portion of data may comprise data that is classified as “non-critical” data.

The first and second number of LBAs may be the same (e.g., the first and second portions of data may be the same size), or the first number of LBAs may be different than the second number of LBAs (e.g., the sizes of the first portion of data and the second portion of data may be different). For instance, the first number of LBAs may be greater than the second number of LBAs (e.g., the size of the first portion of data may be larger than the size of the second portion of data). Further, the size of each respective one of the first number of LBAs may be the same as the size of each respective one of the second number of LBAs, or the size of each respective one of the first number of LBAs may be different than the size of each respective one of the second number of LBAs.

For instance, the size of each respective one of the first number of LBAs may be a multiple of the size of each respective one of the second number of LBAs. Further, the LBAs associated with each respective portion of the memory can be randomized. For instance, the LBAs can be processed by a static randomizer.

In an embodiment, at least two of the plurality of physical blocks of the memory may not have valid data stored therein. For instance, two of the physical blocks of the memory may be blanks. These physical blocks may separate (e.g., be between) the first portion of data and the second portion of data in the memory. For instance, a first one of these two physical blocks may be after the first portion of data and before the second portion of data, and a second one of the two physical blocks may be after the second portion and before the first portion. These physical blocks may be referred to herein as separation blocks.

As illustrated in FIG. 2, host 202 can be coupled to the memory device 206 via interface 204. Host 202 and memory device 206 can communicate (e.g., send commands and/or data) on interface 204. Host 202 can be a laptop computer, personal computer, digital camera, digital recording and playback device, mobile telephone, PDA, memory card reader, or interface hub, among other host systems, and can include a memory access device (e.g., a processor). One of ordinary skill in the art will appreciate that “a processor” can intend one or more processors, such as a parallel processing system, a number of coprocessors, etc.

Interface 204 can be in the form of a standardized physical interface.

For example, when memory device 206 is used for information storage in computing system 200, interface 204 can be a serial advanced technology attachment (SATA) physical interface, a peripheral component interconnect express (PCie) physical interface, a universal serial bus (USB) physical interface, or a small computer system interface (SCSI), among other physical connectors and/or interfaces. In general, however, interface 204 can provide an interface for passing control, address, information (e.g., data), and other signals between memory device 206 and a host (e.g., host 202) having compatible receptors for interface 204.

Memory device 206 includes controller 208 to communicate with host 202 and with the first memory array 210 and the number of second memory arrays 212-1, . . . , 212-N. Controller 208 can send commands to perform operations on the first memory array 210 and the number of second memory arrays 212-1, . . . , 212-N. Controller 208 can communicate with the first memory array 210 and the number of second memory arrays 212-1, . . . , 212-N to sense (e.g., read), program (e.g., write), move, and/or erase data, among other operations.

Controller 208 can be included on the same physical device (e.g., the same die) as memories 210 and 212-1, . . . , 212-N. Alternatively, controller 208 can be included on a separate physical device that is communicatively coupled to the physical device that includes memories 210 and 212-1, . . . , 212-N. In an embodiment, components of controller 208 can be spread across multiple physical devices (e.g., some components on the same die as the memory, and some components on a different die, module, or board) as a distributed controller.

Host 202 can include a host controller to communicate with memory device 206. The host controller can send commands to memory device 206 via interface 204. The host controller can communicate with memory device 206 and/or the controller 208 on the memory device 206 to read, write, and/or erase data, among other operations.

Controller 208 on memory device 206 and/or the host controller on host 202 can include control circuitry and/or logic (e.g., hardware and firmware). In an embodiment, controller 208 on memory device 206 and/or the host controller on host 202 can be an application specific integrated circuit (ASIC) coupled to a printed circuit board including a physical interface. Also, memory device 206 and/or host 202 can include a buffer of volatile and/or non-volatile memory and a number of registers.

For example, as shown in FIG. 2, memory device can include circuitry 214. In the embodiment illustrated in FIG. 2, circuitry 214 is included in controller 208. However, embodiments of the present disclosure are not so limited.

For instance, in an embodiment, circuitry 214 may be included in (e.g., on the same die as) memory 210 and/or memories 212-1, . . . , 212-N (e.g., instead of in controller 208).

Circuitry 214 can comprise, for instance, hardware, and can perform wear leveling operations to relocate data stored in memory array 210 and/or memory arrays 212-1, . . . , 212-N in accordance with the present disclosure. For example, circuitry 214 can relocate the data of the first portion of data that is associated with a particular one of the first number of LBAs to one of the two separation blocks, and can relocate the data of the second portion of data that is associated with a particular one of the second number of LBAs to the other one of the two separation blocks. Circuitry 214 can also manage the logical to physical (L2P) correspondence tables to keep them up-dated with any data relocation, as it will be described in detail.

For instance, circuitry 214 can relocate the data of the first portion that is associated with the last one of the first number of LBAs (e.g., the last LBA in the first sequence of LBAs) to the second separation block (e.g., the separation block that is after the second portion and before the first portion), and circuitry 214 can relocate the data of the second portion that is associated with the last one of the second number of LBAs (e.g., the last LBA in the second sequence of LBAs) to the first separation block (e.g., the separation block that is after the first portion and before the second portion). Such a data relocation may result in two different physical blocks of the memory having no valid data stored therein (e.g., may result in two different physical blocks of the memory becoming the separation blocks).

For instance, relocating the data of the first portion associated with the last one of the first number of LBAs may result in a different physical block becoming the separation block that is after the second portion and before the first portion, and relocating the data of the second portion associated with the last one of the second number of LBAs may result in a different physical block becoming the separation block that is after the first portion and before the second portion. Further, relocating the data of the first portion associated with the last one of the first number of LBAs may result in a different one of the first number of LBAs (e.g., the next-to-last LBA in the first sequence of LBAs) becoming the last one of the first number of LBAs, and relocating the data of the second portion associated with the last one of the second number of LBAs may result in a different one of the second number of LBAs (e.g., the next-to-last LBA in the second sequence of LBAs) becoming the last one of the second number of LBAs.

At each physical block relocation, the L2P tables (not shown in FIG. 2) are also up-dated so that the correct physical block mat be addressed when access to a logical address is requested. According to one embodiment, the L2P table is organized in at least two levels; during operation the first level table is copied in volatile memory for faster speed (the table is also kept in non-volatile memory to avoid losing the information during power-down). The first level table entries point to the second level tables that, in turn, point to physical memory addresses. Second level table is implemented in bit-alterable non-volatile memory, in some examples. A special management of the L2P table may comprise swapping or shifting second level tables corresponding to hot data (e.g., frequently accessed data) to physical locations where second level table corresponding to cold data (e.g., seldom accessed data).

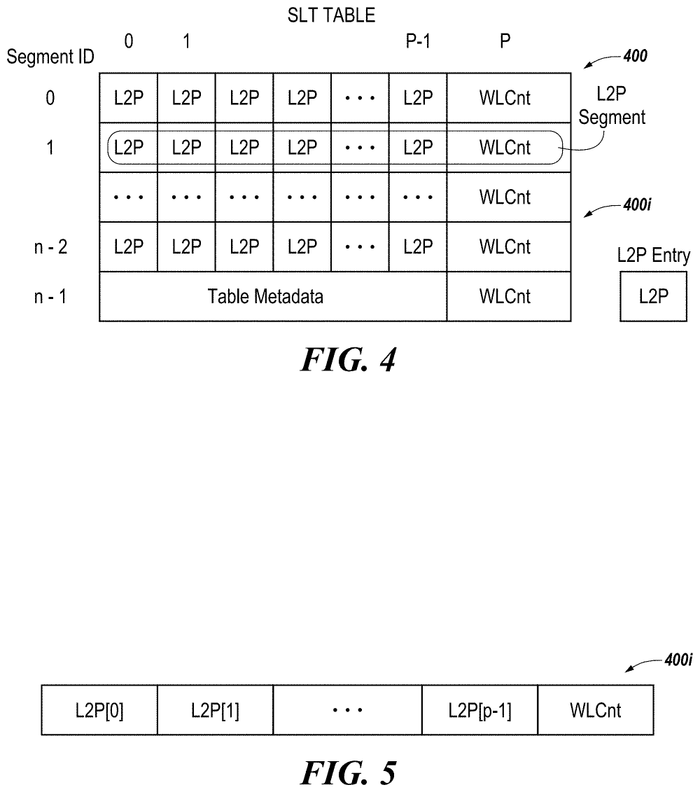

An example illustrating such a data relocation operation and corresponding L2P table updating will be further described herein according to the present disclosure (e.g., in connection with FIGS. 3 and 4).

In an embodiment, circuitry 214 may perform an operation to relocate the data responsive to a triggering event. The triggering event may be, for example, a particular number of program operations, such as, for instance, one hundred program operations, being performed (e.g., executed) on the memory. For instance, a counter (not shown in FIG. 2) can be configured to send an initiation signal in response to the particular number of program operations being performed, and circuitry 214 may perform the operation to relocate the data in response to receiving the initiation signal from the counter. As an additional example, the triggering event may be a power state transition occurring in the memory, such as, for instance, memory device 206 going from active mode to stand-by mode, idle mode, or power-down mode.

In an embodiment, the data of the second portion may be relocated immediately upon the data of the first portion being relocated. However, in some instances, the operation to relocate the data may need to be suspended in order to perform an operation, such as a program or sense operation, requested by host 202.

In such an instance, the operation requested by the host can be performed upon the data of the first portion being relocated (e.g., upon the relocation of the data being completed), and the data of the second portion may be relocated upon the requested operation being performed (e.g., upon the operation being completed).

Circuitry 214 can perform additional (e.g., subsequent) wear leveling operations to further relocate the data stored in memory array 210 and/or memory arrays 212-1, . . . , 212-N throughout the lifetime of the memory. For instance, circuitry 214 can perform an additional (e.g., subsequent) operation to relocate the data responsive to an additional (e.g., subsequent) triggering event.

For example, in an operation to relocate data in the memory that is performed subsequent to the example operation previously described herein, circuitry 214 can relocate the data of the first portion that is associated with the different one of the first number of LBAs that has now become the last one (e.g., the one that was previously the next-to-last LBA in the first sequence of LBAs) to the different physical block that has now become the separation block that is after the second portion and before the first portion, and circuitry 214 can relocate the data of the second portion that is associated with the different one of the second number of LBAs that has now become the last one (e.g., the one that was previously the next-to-last LBA in the second sequence of LBAs) to the different physical block that has now become the separation block that is after the first portion and before the second portion. Such a data relocation may once again result in two different physical blocks of the memory becoming the separation blocks, and different ones of the first and second number of LBAs becoming the last one of the first and second number of LBAs, respectively, and subsequent data relocation operations can continue to be performed in an analogous manner.

The embodiment illustrated in FIG. 2 can include additional circuitry, logic, and/or components not illustrated so as not to obscure embodiments of the present disclosure. For example, memory device 206 can include address circuitry to latch address signals provided over I/O connectors through I/O circuitry.

Address signals can be received and decoded by a row decoder and a column decoder, to access memory arrays 210 and 212-1, . . . , 212-N. Further, memory device 206 can include a main memory, such as, for instance, a DRAM or SDRAM, that is separate from and/or in addition to memory arrays 210-1 and 212-1, . . . , 212-N.

According to previous approaches, NAND memories are used to store physical blocks, firmware code, L2P table and other Flash Translaton Layer FTL information. L2P table provides logical block (LBA) to physical block (PBA) address mapping and it is structured in multiple levels. Since NAND technology is not bit alterable, it is necessary to copy an entire portion of the L2P table in a different page to modify a single PBA.

According to embodiments of the present disclosure, the L2P table is stored in a bit alterable NVM (e.g. 3D XPoint); accordingly, the PBA associated to an LBA can be updated in-place, without moving the portion of L2P table it belongs to.

Typically, only a subset of LBA are frequently written (we will call later this memory sectors as “hot” LBA). This implies that only some entries of L2P table are frequently written, while the others are rarely updated. To reach the target storage device life time, portions of L2P table are moved periodically in different physical positions, so that entries frequently written are stored in different physical addresses (wear leveling). It should be remarked that LBA write distribution changes significantly based on the usage model.

This disclosure defines an improved method to optimize L2P table wear-leveling and a memory device provided with a controller firmware implementing such a new wear-leveling method.

In the following description, embodiments of the present disclosure are discussed in relation to a memory device, for instance a non-volatile memory device, of type defined as “managed” in the sense that an external host device or apparatus 202 can see blocks or memory portions known as logical block address (LBA).

On the contrary, the resident memory controller 208 and the associated firmware is structured to organize the physical space of the memory device in locations knows as physical block addresses (PBA) that may be different from the logical block addresses (LBA).

In other words, the logical and physical organization of the memory device are different and a L2P (meaning Logical-to-Physical) table is provided reporting a correspondence between the logical address used by the external entity (for instance the host device) and the physical address used by the internal controller and its firmware. According to other embodiments, the P2P table may be directly managed by the host, with the necessary adaptations that will be obvious to the expert in the field.

Now, an L2P table is generally structured as a non-volatile Flash or NAND memory portion having a predetermined granularity in the sense that it is not bit alterable and does not allow to perform an update-in-place of a memory cell. On the contrary, a 3D Cross Point non-volatile memory device would allow to perform an update even of a single bit.

FIG. 3 shows a schematic view of the logic structure of an L2P table according to the present disclosure wherein at least a first level indicated by the box FLT (First Level Table) is stored in the physical location tracing one of a plurality of second level tables indicated by the blocks SLT (Second Level Table).

In a page based FTL, L2P table provides the physical block address (PBA) from each logical block address (LBA). L2P table is structured in multiple levels. FIG. 3 shows a two-level structure: the first level (FLT) contains physical pointers to second level tables (SLT). More levels may be present in some embodiments, e.g., including a first level table, a second level table and a third level table, depending on the apparatus design and capacity, for example. In this disclosure, SLT tables are stored in physical locations called Physical Table Address (PTA). SLT table contains L2P entries.

There is a L2P entry for each LBA. A L2P entry specifies the PBA and it may contain other LBA specific information. The first level table is copied in SRAM, while SLT tables are in NVM. Each SLT table is specified by a TableID.

TableID ranges from 0 to RoundUp(DevCapacity/SLTSize)−1, where:
DevCapacity is the number of LBA
SLTSize is the number of entries in a SLT table.

With a bit-alterable NVM, such as 3D XPoint, L2P entries can be updated in-place, without moving the whole SLT table it belongs to. Let's see how.

Normally, the FLT is always loaded into a volatile memory portion, for instance a RAM memory portion, during the start-up phase of the memory device, i.e. during the boost phase. This means that the physical location and the physical structure of the first level table is different from that of the other second level tables.

The second level table is a table storing the pointers that are used to translate for each single LBA the physical position with respect to the indicated logical position.

In other words, any time that a host device needs to re-write or update a single LBA it's necessary to trace the correct physical location wherein that data has been stored. Moreover, even the second level table containing the pointers to the physical locations must be updated accordingly.

The host gives just the indication of the logical address to be updated and the controller firmware must take care of performing the mapping and the appropriate update on the correct physical location tracing such a location thanks to the L2P table.

At any update requested by the host device a corresponding update of the pointer stored in the second level table of the memory device will be performed.

According to the present disclosure the second level tables are structured with non-volatile memory portions that are bit alterable, for instance 3D Cross Point (3D Xpoint) memory portions. This has the great advantage to allow a so-called update in place or, in other words, to update the same physical location of a pointer.

In the addressable space visible by the host there are memory portions or locations or areas that may be defined as “hot” in the sense that there is a relatively frequent access to such hot memory areas while other memory portions or locations or areas may be defined as “cold” in the sense that they are seldom accessed.

Therefore, in consideration of the possibility to update-in-place the same pointer with a certain frequency it may happen that the memory cells used for storing those pointers would become aged much earlier than other memory areas.

This could be a very serious problem since a memory device including an aged memory portion may dramatically reduce its performances or risks to get out of service generating so frequent errors toward to host device to become useless.

This problem has already been faced employing wear leveling algorithms that are capable to monitor the number of times that physical addresses are written and shift the logical to physical mapping based on write counters values.

However, the known solutions provided by some wear leveling algorithms do not allow to improve the life of the memory device as expected and the present disclosure has the purpose to teach a new wear leveling mechanism capable to overcome the limitations of the above-mentioned known solutions.

In this respect, a great importance is given to the organization of the second level table STL that will be disclosed hereinafter with reference to the example of FIG. 4. Thanks to such an organization is possible to adopt the inventive wear leveling method of the present disclosure.

FIG. 4 shows a schematic view of an SLT table including a plurality of N segments 0, 1, . . . , n−1, organized as rows of a matrix 400 while a plurality P of matrix columns are completed by a final counter WLCnt.

FIG. 4 shows schematically the SLT table structure. Each SLT table includes n L2P Segments. The L2P Segment is the granularity at which SLT table may be read or written. A L2P Segment may contain L2P Entries or Table Metadata.

There are a plurality of P L2P entries in a L2P Segment, see FIG. 4. Each L2P Segment contains a wear leveling counter (WLCnt). This counter is incremented each time the L2P Segment is written and its value is used by the dynamic wear leveling algorithm.

When the wear leveling counter of a SLT segment reaches a defined threshold, the whole SLT table it belongs to is moved to a different physical location, and all wear leveling counters of such SLT table are reset to zero.

An indication of when a table has been moved to its physical location is stored in the L2P table metadata. A monotonic counter (TableStamp) is incremented at each SLT table move. When a table is moved, the current TableStamp value is copied into the table metadata.

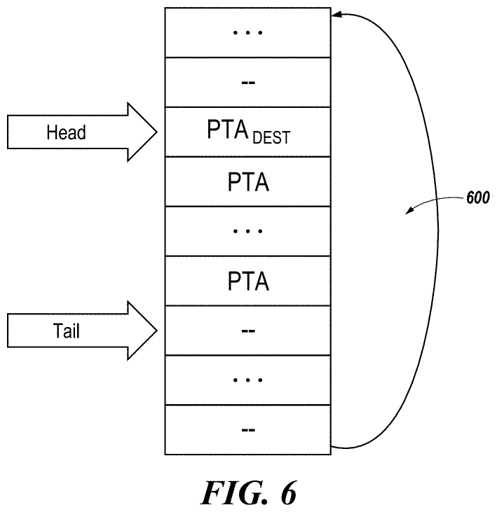

The physical area dedicated to store L2P table is bigger than what needed because it contains some spare PTA used when tables are moved. Spare or available PTAs physical table addresses are stored in a list, PTA List, as shown in FIG. 6. The PTA List is organized as a circular buffer. The head of PTA List points to the PTA to be used as destination address in a table move (PTADEST). After a table has been moved, the former PTA is added to the tail of the PTA List.

As said, each segment 400i of this second level table represents the minimal granularity with which it is possible to update the pointers to the memory device. In other words, when there is the need to change a pointer and to update a single entry of a segment, it is necessary to re-write the whole segment including that specific entry.

The operations performed at each updating phase are in a sequence: reading, update-in-place and writing of the whole table segment. Obviously, the other table segments are not involved during an updating phase of a generic K-th segment.

Each box of the matrix 400 is represented by the label L2P and indicates the presence of a pointer of a physical memory location corresponding to a generic external logical block address LBA. With the term external we wish to indicate the request done by the external host toward the addressed memory device.

FIG. 5 shows a more detailed view of a single segment 400i including a plurality of pointers L2P [O], . . . , L2P [P−1] followed by a wear leveling counter WLCnt, sometimes also referred to as segment counter or simply a counter.

The final row n−1 of the matrix 400 includes table metadata and a final counter. The metadata segment is written when a table is shifted, only.

The final column of the SLT table matrix 400 includes only counters each one configured for counting the number of times that a given sector has been updated. The increment of the value stored in the corresponding counter allows to keep a record of the updating phase.

When the recorded value contained in one of the counters of the column P, that is indicative of the number of re-writing cycles, has reached a predetermined threshold, then the whole pointers table is moved to another PTA.

The content of the counter is known because any time there is a need of an update the sequence of operations involved by an update includes: reading phase, updating-in-place and re-writing. Therefore, the content of the counter record is read at the beginning of the updating phase.

In this manner the controller firmware taking care of the updating phase immediately realizes that the value of the counter is over the set threshold and starts a programming phase for shifting or copying the table in another physical position of the memory device.

For clarity, the above sentence means that a given secondary level logic table is shifted in a different physical location (PTA).

However, this solution does not allow to fully exploit the plurality of segments incorporated in a given second level table.

The present disclosure does solve this further problem and provides a more efficient wear leveling solution based on a more detailed evaluation of the aged segments.

The last metadata segment contains information useful for identifying the selected secondary level table in the corresponding physical location but the counter associated to such metadata sector, that will be called “final counter”, contains a summary value indicative of how many shifts have been performed. An indication of how “hot” is the table itself is stored in the TableStamp field of the Table Metadata segment.

This final counter is set to “0” at the very beginning and is incremented any time that the corresponding table is shifted in a new physical position thus giving a dynamic indication about the “status” of the corresponding table including that final counter.

The combined information of the metadata sector and the final counter allow identifying a complete status of a given SLT table in the sense that the metadata sector contains the information about the i-th table stored in the k-th physical location while the final counter shows how many table displacements happened.

Comparing the values of two or more final counters, or simply comparing the value contained in a final counter with the threshold value (that may be a second threshold value different from the threshold value used for triggering the shifting of the SLT), it is possible to associate a qualitative label (for instance “hot” or “cold”), e.g. a usage-indicator, to a table and to include such a table in a displacement program or not.

The cross information obtained by the counters associated to each corresponding sector and by the final counter associated to the metadata sector may be combined for taking the decision if shift or not a given table.

For example: if a single counter should increment its value up to an amount that meets or overcomes a predetermined threshold, it would automatically generate a firmware request to shift that whole table but, if the final counter would be indicative of a so-called “cold” table, this information could be combined with the previous one for a possible delay of the shift since that table has not been exploited very much in recent times.

The information of the final counter is so important that may have a priority over the information concerning a single segment so that the physical position of a “cold” table could be offered as possible physical location for hosting the content of other less cold, or better, hot tables.

This possibility is regulated by a corresponding algorithm that we will see hereinafter.

FIG. 6 shows a circular list 600 of physical positions indicated as Physical Table Address PTA and normally used for changing or shifting the positions of the so-called hot tables. An entry of this list 600 indicates the free physical position (PTA) available to store the tables.

Any time that is necessary to shift a table in a new position, no matter for which reason, it's necessary to pick up a physical position PTA from the top side or head of this list while the removed table is put in the tail position of the list. In other words, the list is managed according to a queueing rule FIFO (First In First Out) wherein the old physical position of a table that is shifted in a new physical location is added or queued to the last available position of the tail.

Of course, we are here considering for the purpose of the present disclosure that the total number of available spaces for the tables (PTA) is greater that the number of tables.

The mechanism proposed in the simple list of FIG. 6 is rigid in the sense that the cycling of the “hot” and “cold” tables is just cyclical.

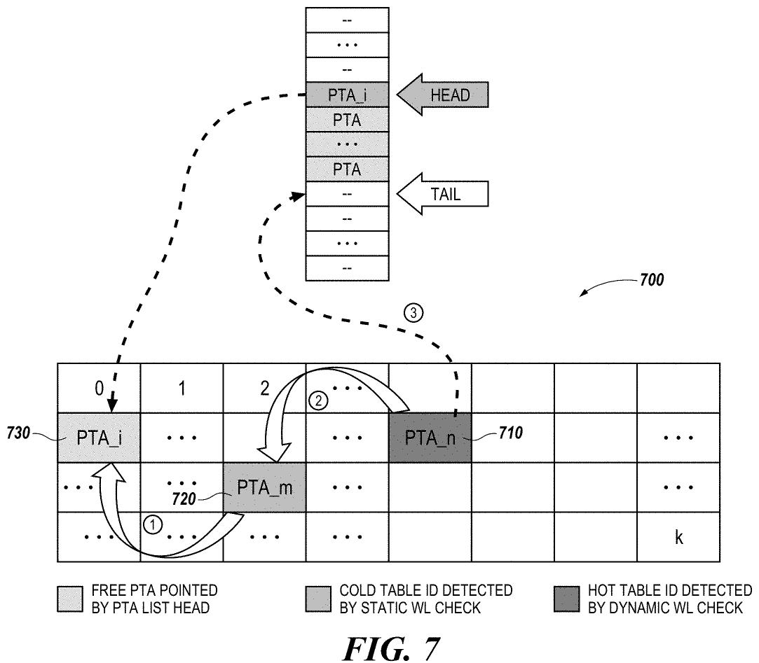

FIG. 7 is another schematic view showing the list of FIG. 6 in combination with a new proposed table swapping mechanism according to the present disclosure.

FIG. 7 illustrates how the wear leveling algorithm of the present disclosure swaps hot SLT table with cold SLT one. Each time a L2P Segment is written, its wear leveling counter is incremented. When the counter reaches the defined threshold (DynWLTh), the whole SLT table is moved from its current physical location (PTA_n) to a different one.

If a cold SLT table was previously identified stored at PTA_m, then the cold SLT Table is moved to the PTA at the head of the PTA List (PTA_i). Then, the hot SLT table is moved where the cold SLT table was previously (PTA_m) and its PTA (PTA_n) is appended to the PTA List. If there is no cold Table identified, there is no table swapping and the hot SLT table is moved to the PTA_i taken from the head of the PTA List.

Cold PTA selection is performed through a periodical scan of all SLT table metadata: the TableStamp stored in the metadata field is compared with current TableStamp value. The SLT is cold if the difference between the two values is greater than a threshold (StaticWL).

The table 700 shown in FIG. 7 represent the possible K memory positions PTA that are available for storing the SLT tables.

The box 710 is indicative of a PTA position corresponding to a table that has been identified as hot according to the dynamic wear leveling method previously disclosed.

The box 720 is indicative of a PTA position corresponding to a table that has been identified as cold according to the static wear leveling method previously disclosed.

The box 730 is indicative of a generic and free PTA position that has been identified as the first available and to be used in the list of FIG. 6 (e.g., at the head of the list).

The method according to the present disclosure suggests shifting, or swapping, the cold table 720 to the first available position represented by the table 730. This step is shown by the arrow (1) reported in FIG. 7.

Since the position of the cold table is now free, instead of rendering such a position available at the list tail, as suggested by the prior solutions, it will be used to host the hot table 710.

Therefore, according to the present disclosure, as a second step (2) the hot table 710 is shifted, or swapped, to the position of the cold table 720.

Finally, in step (3) the table 710 is queued in the tail position of the list of FIG. 6.

In this manner:
portions of L2P table that contain frequently written entries (hot tables) are swapped with the ones that are rarely written (cold);
the threshold that identifies cold portions is automatically adjusted based on workload characteristics.

In other words, the firmware has swapped a hot logic table writing it in a physical position that was previously occupied by a cold logic table. At the same time, the cold logic table has been written in the first physical position available for swapping a hot table in the list of FIG. 6.

The above-disclosed mechanism works correctly only if it is possible to detect properly the so-called cold tables.

Write counters are compared with thresholds to determine when mapping should be modified. It is necessary to properly set thresholds based on workload to optimize performance. Wrong thresholds may result in shorter device life time, either because the data that is frequently written could not be remapped enough frequently to different physical addresses or, at the opposite, because this remap occurred too frequently.

A staticWL threshold value is a critical wear leveling algorithm parameter. If it's too high, it may be difficult to find a cold table for swapping, and hot tables would be moved to PTAs retrieved from the PTA List. Note that PTA in the PTA List are mainly used for other hot tables. On the other hand, if the StaticWL threshold is too low, then PTA found may have been used already for other hot tables and the swapping would not have benefit. Unfortunately, the optimal value for the StaticWL threshold depends on the hotness characteristics of the workload, therefore it cannot be predefined in a simple way. To solve this issue, a self-adaptive StaticWL threshold algorithm is defined and disclosed.

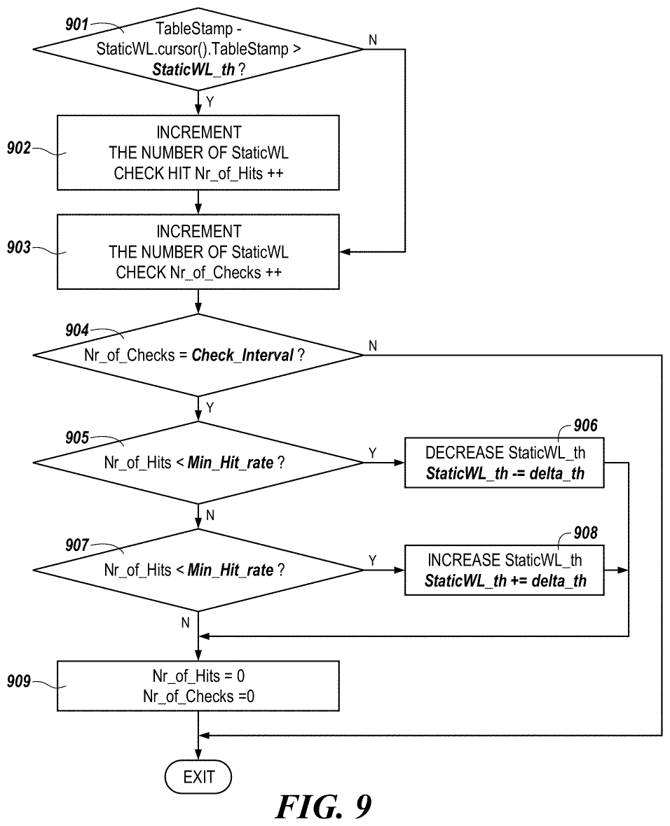

As will be later illustrated in FIG. 9, at the end of each StaticWL Check_interval, the number of hits is evaluated. If too few PTAs have been found to be static (Min_Hit_rate), it means that the current StaticWL threshold is too high, then its value is decreased by delta_th.

On the other hand, if too many PTAs have been found to be static (Max_Hit_rate), it means that the current StaticWL threshold is too low, then its value is increased by delta_th. Changing the value of StaticWL Check_interval and delta_th, it's possible to control the reactivity of the algorithm to follow the workload changes.

In the proposed method, thresholds are adjusted automatically according to the workload characteristics.

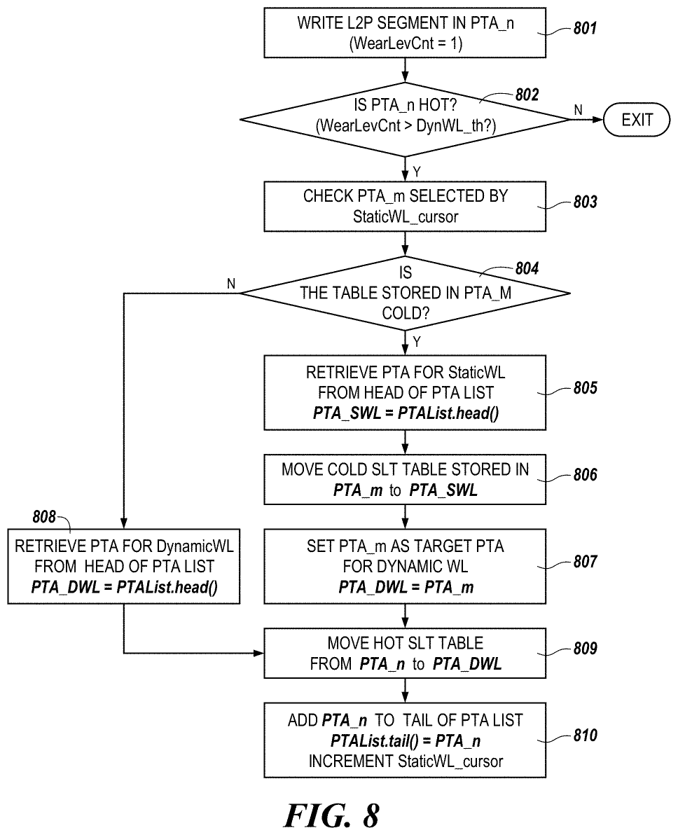

FIG. 8 shows in the form of a flow chart the main steps of an algorithm implementing the method of the present disclosure. The static WL scan is performed at the same rate of the table move, and the possible cold table found is immediately used in the table swap. Alternatively, a list of cold tables may be prepared in advance.

At step 801, each time a L2P Segment is written in PTA_n, its wear leveling counter is incremented (i.e. WearLevCnt+=1). Then, the method proceeds to the test step 802, where it is determined whether the table stored in PTA_n is hot or not.

In other words, if the counter reaches the defined threshold (DynWL_th), i.e. WearLevCnt>DynWL_th, it is determined that the table stored in PTA_n is hot. Otherwise, it is determined that the table stored in PTA_n is not hot.

If the table stored in PTA_n results to be not hot, the method ends and exits.

On the contrary, if the PTA_n is determined to be hot, the method proceeds to step 803, wherein the PTA_m selected by StaticWL_cursor is checked.

The StaticWL_cursor is also called as StaticWL threshold which has been described in the above. Then, at the test step 804, it is determined whether the table stored in PTA_m is cold. The determination method is the same previously disclosed and thus it is not described any more for avoiding redundancy.

If the table stored in PTA_m is determined to be cold, the method proceeds to step 805, wherein it is required to retrieve a free PTA for Static WL from head of PTA List (i.e. PTA_SWL=PTAList.head( )).

Then the method proceeds to step 806, where the cold SLT table stored in PTA_m is moved to PTA_SWL which was retrieved at the step 805. In this case, the PTA_m is set as a target PTA for DynamicWL at step 807, i.e., PTA_DWL=PTA_m. then, the method proceeds to step 809, where the hot SLT table is moved from PTA_n to PTA_DWL.

If the table stored in PTA_m is determined to be not cold, the method proceeds to step 808, where it is required to retrieve a free PTA for DynamicWL from head of PTA list (i.e. PTA_DWL=PTAList.head( )).

Both steps 807 and 808 proceed with step 809 wherein the hot SLT table is moved from PTA_n to PTA_DWL which was retrieved at the previous step.

After the hot SLT table has been moved from PTA_n to PTA_DWL, the method proceeds to step 810, where PTA_n is added to the tail of PTA List, i.e. PTAList.tail( )=PTA_n, and the StaticWL_cursor is incremented.

FIG. 9 shows the algorithm flowchart concerning the method to manage a self-adaptive static wear leveling threshold.

The method begins with step 901, wherein the TableStamp stored in the metadata field is compared with current TableStamp value (i.e. TableStamp−StaticWL.cursor( ).TableStamp>StaticWL_th?).

If the difference between the two values is greater than a threshold (StaticWL_th), then the SLT table is set to be cold.

Then the method proceeds to step 902, wherein the number of StaticWL check hit is incremented, i.e. Nr_of Hits++. while the number of StaticWL check is incremented (i.e. Nr_of Checks++) at step 903.

If the difference between the TableStamp stored in the metadata field and the current TableStamp value is not greater than the threshold (StaticWL_th), the method proceeds to the step 903 directly.

Then, at the end of each StaticWL Check_interval, the number of hits is evaluated. At step 904, it is determined whether the number of StaticWL check is equal to the StaticWL Check_interval (i.e. Nr_of Checks=Check_interval?).

If it is not the end of the StaticWL Check_interval and, in other words, if the number of StaticWL check is not equal to the StaticWL Check_interval, the method ends and exits.

If the number of StaticWL check is equal to the StaticWL Check_interval, it means the end of the StaticWL Check_interval. And then the number of hits is evaluated.

At step 905, if too few PTA have been found to be static (i.e. Nr_of Hits<Min_Hit_rate), which means that the current StaticWL threshold is too high, its value is decreased by delta_th (i.e., StaticWL_th−=delta_th) at step 906. Afterwards, the method ends and exits.

On the other hand, if not, it is determined whether too many PTA have been found to be static (i.e. Nr_of Hits>Max_Hit_rate?) at step 907. If too many PTA have been found to be static, which means that the current StaticWL threshold is too low, its value is increased by delta_th (i.e., StaticWL_th+=delta_th) at step 908. Afterwards, the method ends and exits.

Changing the value of StaticWL Check_interval and delta_th, it's possible to control the reactivity of the algorithm to follow the workload changes.

At the end of each StaticWL Check_interval, the number of StaticWL check hit (Nr_of Hits) and the number of StaticWL check (Nr_of Checks) are both reset to zero (i.e., Nr_of Hits=0 and Nr_of Checks=0); then, the method ends and exits at step 909.

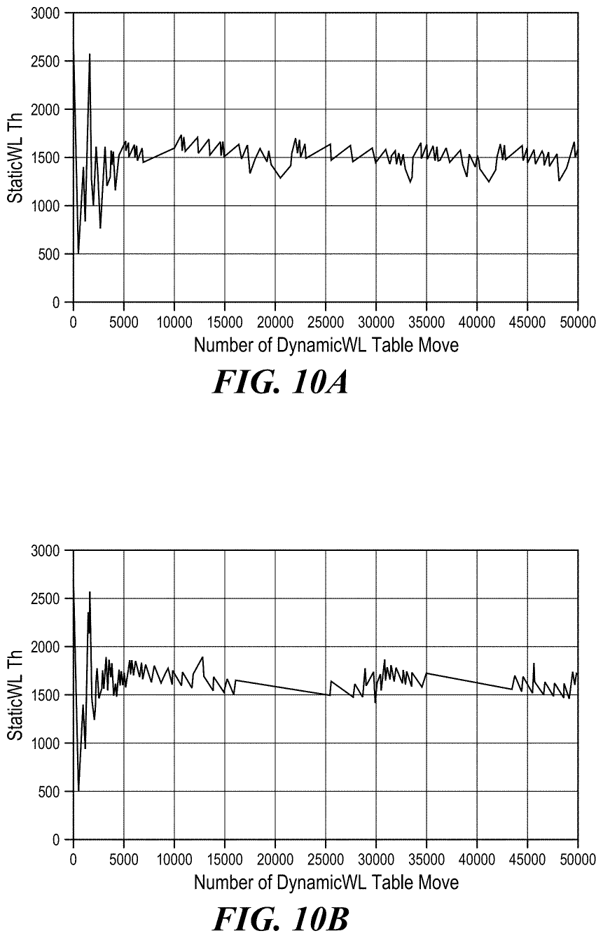

FIG. 10 shows an example of how the self-adjustment algorithm operates with two workloads having different hotness characteristics.

As can be seen from FIG. 10, the StaticWL thresholds are adjusted automatically according to the workload characteristics.

In the two diagrams: (a) moderate hotness workload and (b) high hotness workload, the StaticWL thresholds changes in different ways. Specifically, under the moderate hotness workload, the StaticWL thresholds are adjusted at a relative small frequency, while under the high hotness workload, the StaticWL thresholds are adjusted at a relative great frequency. The self-adjustment algorithm has already been described previously.

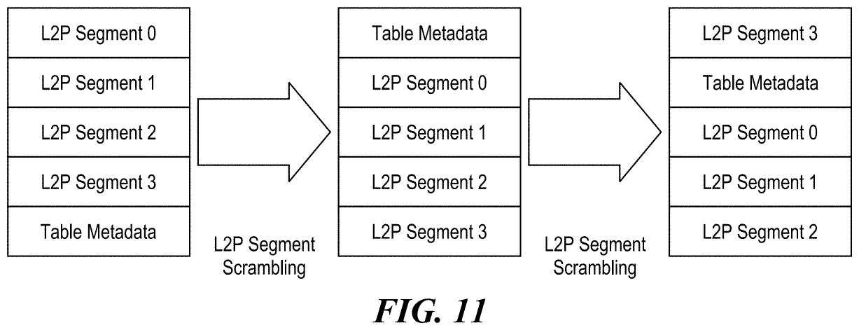

Now, with further reference to the example of FIG. 11, it will be disclosed another aspect of the wear leveling method of the present invention based on a L2P table entries scrambling.

A further improvement for wear leveling can be achieved scrambling L2P Segments within SLT table.

This further aspect of the inventive method starts from the consideration that the L2P Table metadata is written less often than L2P Segments; therefore, there is a benefit in moving its physical position in the SLT table layout.

Moreover, within a SLT table there can be L2P entries written much more often than others. Address scrambling should ensure that L2P Segments are written in different physical positions when a table is mapped on the same PTA.

SLT tables are specified by a TableID and their physical position by the PTA.

FIG. 11 shows an implementation example for three subsequent writing cycles of a SLT Table on the same PTA.

Moreover, a hash function may be used to generate L2P Segments scrambling. To avoid that the table metadata is stored always in the same physical location, it's enough to use the TableID in the hash function input. Since TableID is table specific, the hash function returns different L2P Segment scrambling when different tables are mapped on the same PTA.

The randomization of L2P Segments scrambling can also be obtained by using the TableStamp instead of the TableID. This method avoids generating the same scrambling when a table is mapped to the same PTA multiple times.

An example of hash function is the modulo function. If the table contains N L2P Segments, an offset is calculated as in the following:

Offset=Table ID mod N

Then, the Offset is used to obtain the scrambled L2P Segment ID:

Scrambled Entry ID=(Entry ID+Offset)mod N

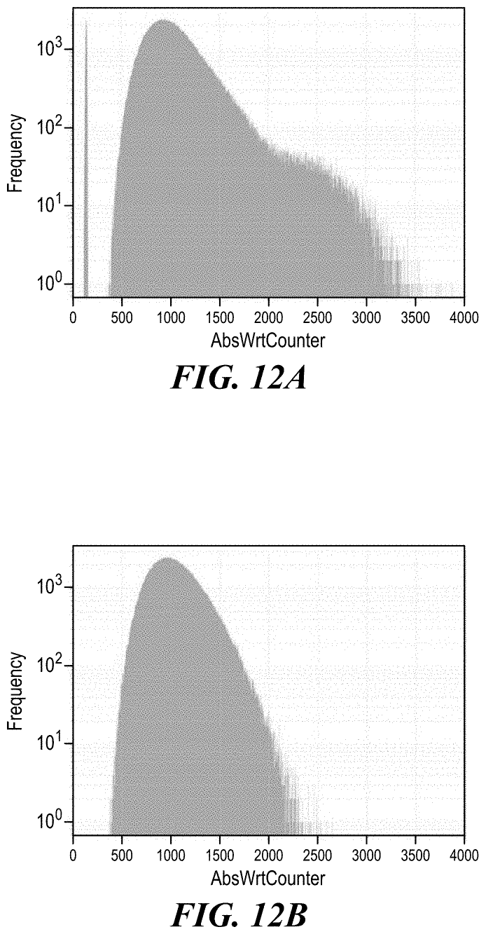

FIG. 12 shows the result of simulations with and without L2P Segment scrambling.

The result of simulations indicates a significant decrease of the write counter values with L2P Segment scrambling, compared to the situation without L2P Segment scrambling. With the L2P Segment scrambling, the L2P write cycles decrease, which thus can improve the life of the memory device as expected.

The method suggested in the present disclosure improves the table swapping thus extending the life of the memory device. This solution has a great advantage since it is known that portions of the memory device are accessed only seldom by the applications running on the electronic device in which the memory device is installed (i.e. a mobile phone or a computer or any other possible device).

With the hot and cold table swapping method of the present disclosure even the remotely accessed portion of the memory device are used for a better and more regularly distributed writing phases of the memory device.

1-29. (canceled)

30. A method for self-adaptive wear leveling of a managed memory device, comprising:
addressing, by a first level table, a plurality of second level tables including pointers to a managed memory device;
detecting a number of updating phases of a segment of a first one of the plurality of second level tables; and
shifting the first one of the plurality of second level tables to a location of a second one of the plurality of second level tables based on the number of updating phases meeting a defined threshold.

31. The method of claim 30, wherein detecting the number of updated phases comprises reading a value of a wear leveling counter provided in a same segment as an entry of the first one of the plurality of second level tables.

32. The method of claim 31, further comprising shifting the first one of the plurality of second level tables to the location of the second one of the plurality of second level tables based on the wear leveling counter reaching the defined threshold.

33. The method of claim 30, further comprising incrementing a wear leveling counter of each of a plurality of segments of the first one of the plurality of second level tables each time a corresponding one of the plurality of segments is written, updated, or a combination thereof.

34. The method of claim 33, wherein shifting the first one of the plurality of second level tables comprises resetting to zero each wear leveling counters of each of a plurality of segments.

35. The method of claim 30, further comprising shifting the first one of the plurality of second level tables subsequent to a cross check of information obtained by wear leveling counters associated with respective segments of the each one of the plurality of second level tables and by a final counter associated with a metadata segment of the first one of the plurality of second level tables.

36. The method of claim 1, further comprising scrambling logical-to-physical segments within the first one of the plurality of second level tables.

37. The method of claim 36, further comprising scrambling the logical-to-physical segments using a hash function to generate a scrambling sequence of the first one of the plurality of second level tables, the hash function returning different logical-to-physical segments scramblings responsive to different tables of the plurality of second level tables being mapped on a same physical second table address.

38. A memory device, comprising:
a table of correspondence between a logical memory address and a physical memory address, comprising:
a first level table addressing a plurality of second level tables including pointers to the memory device; and
a plurality of segments in one of the plurality of second level tables, each of the plurality of segments comprising a counter for detecting a number of updating phases of a corresponding one of the plurality of segments,
wherein the memory device has a logical organization different than its physical organization.

39. The memory device of claim 38, wherein:
the plurality of second level tables comprise non-volatile memory portions that are bit alterable; and
the bit alterable non-volatile memory portions are three-dimensional (3D) cross-point memory portions.

40. The memory device of claim 38, further comprising firmware to:
detect increments to a wear leveling counter associated with a segment of the one of the plurality of second level tables; and
shift the one of the plurality of second level tables to a different physical location based on a number stored in the wear leveling counter meeting or overcoming a defined threshold.

41. The memory device of claim 38, wherein:
the one of the plurality of second level tables comprises a plurality of segments; and
a final segment of the plurality of segments is used as a table metadata and comprises a final counter associated with the final segment.

42. The memory device of claim 41, further comprising the final counter configured to be incremented each time the one of the plurality of second level tables is sifted to a different physical location.

43. The memory device of claim 41, further comprising firmware to shift the one of the plurality of second level tables to a different location based on a result of a comparison between a counter associated with one of the plurality of segments and a first threshold, a comparison between the final counter associated with a final segment and a second threshold, or a combination thereof.

44. The memory device of claim 38, further comprising a list of available physical table addresses configured to be updated at every shift to a different physical location by the one of the plurality of second level tables or at every shift to a different physical location by a different one of the plurality of second level tables.

45. An apparatus, comprising:
a managed memory device; and
a host device coupled to the managed memory device and comprising:
a memory structure having different logical and physical organizations and comprising a table of correspondence between logical memory addresses and physical memory addresses, wherein the memory structure comprises:
a first level table addressing a plurality of second level tables including pointers to physical addresses in the managed memory device; and
a plurality of segments in the plurality of second level tables, each of the plurality of segments comprising a segment counter for detecting a number of updating phases of the corresponding one of the plurality of segments.

46. The apparatus of claim 45, wherein the plurality of second level tables comprises non-volatile memory portions that are bit alterable.

47. The apparatus of claim 46, wherein the bit alterable memory portions are three-dimensional (3D) cross point memory portions.

48. The apparatus of claim 45, wherein the plurality of second level tables comprise metadata segments and final counters associated with respective metadata segments.

49. The apparatus of claim 45, wherein each table of the plurality of second level tables is configured to be shifted to a different physical location based on a result of a comparison between a counter associated with each table and a first threshold, a comparison between a final counter associated with a final segment of each table and a second threshold, or a combination thereof.
